(19) United States
(12) Patent Application Publication
(10) Pub. No.: US 2005/0135458 A1
(43) Pub. Date: Jun. 23, 2005

(54) System and method for distance assistance and coaching

(75) Inventors: David W. Graves, Appleton, WI (US); Ronald C. Hammer, West Bend, WI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Sovus Media, Inc., Appleton, WI (US)

(21) Appl. No.: 10/994,898

(22) Filed: Nov. 22, 2004

Related U.S. Application Data
(60) Provisional application No. 60/525,472, filed on Nov. 26, 2003.

(51) Int. Cl. H04B 1/69; H04B 1/707; H04B 1/713; G06F 15/173

(52) U.S. Cl. 375/130

(57) ABSTRACT

A distance assistance system including a plurality of remote locations connected to a central location through a network, wherein an operator at the central location selects a particular remote location to monitor. Each remote location includes a number of video cameras, the video signals generated by the video cameras is transported through the network to the central location and allows the operator to visually monitor in real time the remote location. Each remote location also includes a number of audio transceivers, allowing the operator at the central location to monitor real time audio information from the remote site, as well as communicate verbally in real time with representatives located at the remote site.

### CROSS-REFERENCE TO RELATED APPLICATION(S)

This application claims the benefit of U.S. Provisional Application No. 60/525,472 filed Nov. 26, 2003 for “Operations Command Center” by David W. Graves and Ronald C. Hammer.

### BACKGROUND OF THE INVENTION

The invention relates generally to remote site monitoring and communication. Specifically, the invention is a system and method for monitoring, assisting, and coaching representatives at a number of remote locations from a central location.

Many organizations today are faced with the task of managing a number of remote locations. For example, retail companies often maintain and manage a number of remote store locations. Maintaining a uniform customer experience in terms of appearance of each location, as well as in employee conduct and customer interaction, becomes difficult. For example, new employees require training and coaching typically provided by a more experienced manager or supervisor. Having an experienced manager or supervisor at every location at all times is difficult for many growing companies. In particular, companies are often faced with high turnover rates, meaning experienced managers and supervisors may not be available at all locations. Many locations may only require a single employee to operate, in which case training and coaching from a supervisor on a daily basis would not be feasible. Typical training may include guidance on how employees should interact with customers, the appropriate appearance of store displays, and appropriate attire for store employees. In situations which an experienced manager or supervisor is not present, inexperienced employees are left with the task of maintaining the appearance of the store properly during many business hours, as well as assisting customers in the appropriate manner, without feedback or guidance from an experienced manager. If a particular remote location does not require the everyday presence of a manager or supervisor, some sort of check is required to ensure that employees scheduled to work are present at the appropriate time. In a typical system, this may require a physical visit or phone call to each remote location at a certain time to ensure the scheduled employees are indeed present.

Other challenges include informing employees at remote locations of changing promotional programs, products, and company policies. Providing consistent communications between the company and the employees working at each remote location is difficult. This is especially true for companies without managers and supervisors in each store. It is also not unusual for customers to have questions that an inexperienced employee either cannot answer, or does not have the authority to answer. In these situations, typically the employee requires the assistance of a manager with the authority or experience to handle the customer's question. In situations in which no manager or supervisor is present, the employee will be unable to assist the customer.

The problem of supervising and managing a number of remote locations is not limited to retail companies. Service companies as well as government: organizations are often faced with the task of monitoring and assisting representatives at a number of remote locations.

### BRIEF SUMMARY OF THE INVENTION

A system and method is described for providing distance assistance. The system includes at least one remote location and a central location. An operator at the central location selects one or more remote locations to visit. Each remote location includes video means for providing real time visual information from the remote location, which is transmitted to the central location through a network. A two-way audio means for providing real time audio communications between the operator at the central location and a representative selected by the operator at the remote location allows the operator to provide real time coaching and training of representatives at remote locations.

### BRIEF DESCRIPTION OF THE DRAWINGS

FIG. 1 is a block diagram showing the overall arrangement of the distance assistance system of the present invention.

FIG. 2 is a block diagram showing the arrangement between a single remote location and the control center shown in FIG. 1.

FIG. 3 is a perspective view of the remote location of the present invention.

FIG. 4 is a perspective view of control center of the present invention.

FIG. 5 is a flow chart illustrating a method of operation between the control center and the remote location.

### DETAILED DESCRIPTION

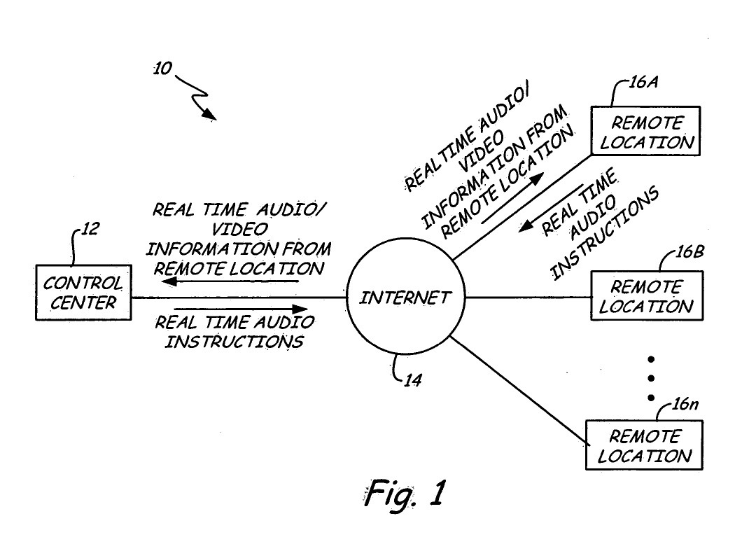

FIG. 1 is a block diagram illustrating an exemplary embodiment of the overall arrangement of distance assistance system 10. Distance assistance system 10 includes control center 12, Internet 14, and a plurality of remote locations 16A, 16B . . . 16n. Discussion of remote locations generally are referred to as remote locations 16, whereas discussion of a particular remote location is assigned a suffix such as remote location 16A. Each remote site 16 is connected to control center 12 via Internet 14. Internet 14 refers to an infrastructure network used to connect and transmit data between computers. In one exemplary embodiment, as many as fifty remote sites 16 are monitored by control center 12, although this in no way limits the number of remote sites 16 that may be monitored by control center 12. Examples of remote sites 16 include mall kiosks, store locations and service centers, although this list is not exhaustive. Control center 12 does not need to be physically close to remote sites 16.

An operator at control center 12 selects a remote site 16 to visit. For example, as shown in FIG. 1 the operator selects remote location 16A. The operator receives both audio and visual real time information from remote site 16A, through Internet 14, allowing the operator to assess current conditions at remote location 16A. In some instances, the operator may decide to rely only on real time visual information from remote site 16A, and other times may decide to both look and listen to remote site 16A. If an opportunity to provide assistance to a representative working at remote location 16A, or to provide coaching or training information to the representative arises, the operator opens up an audio communication channel with the representative, through Internet 14. The operator and the representative are able to communicate with one another in real time audio until the issue or coaching has been completed. The operator is then able to select another remote location, for instance remote location 16B, to visit. In another embodiment, the operator is able to visually monitor a number of remote locations 16 simultaneously.

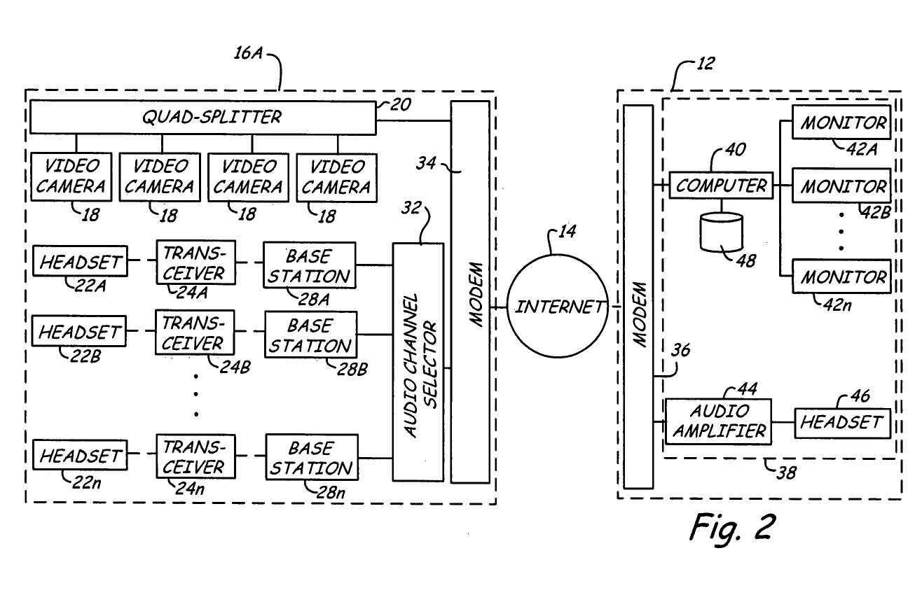

FIG. 2 is a block diagram illustrating an exemplary embodiment of the present invention, showing the arrangement between remote location 16A and control center 12. Remote site 16A includes a number of cameras 18, video quad-splitter 20, a number of headsets 22A-22n, a number of wireless transceivers 24A-24n, a number of base stations 28A-28n, channel selector 32, and audio/visual modem 34. Visual information regarding the status of remote site 16 is collected by cameras 18. Each camera is 18 is connected to quad-splitter 20. Quad-splitter 20 combines video signals from up to four cameras 18 into a single signal, allowing the video information received by up to four cameras to be displayed on a single monitor. By displaying video information from four cameras on a single monitor, it allows an operator at control center 12 to monitor an entire remote location at one time. The output of quad splitter 20 is connected to audio/visual modem 34, which prepares the video signal for transport over Internet 14. In the exemplary embodiment shown in FIG. 2, cameras 18 are not equipped with audio receivers, although this feature may be used in other embodiments.

In the exemplary embodiment shown in FIG. 2, audio communication between remote site 16A and control center 12 is done through headsets 22. A number of headsets 22A-22n are allocated to each remote location 16, depending on the number of employees expected to be working at any one time. Each headset 22 includes an earpiece and a microphone, allowing two-way audio communication. Headsets 22A-22n are worn by representatives at remote location 16, and both receive and transmit audio signals through wireless transceivers 24A-24n, which are also worn by the employee. Each wireless transceiver 24 is associated with a particular base station 28. For instance, headset 22A is associated with wireless transceiver 24A, and headset 22B is associated with wireless transceiver 24B. Similarly, each base station 28 is associated with a particular wireless transceiver 24. For instance, wireless transceiver 24A is associated with base station 28A, and wireless transceiver 24B is associated with base station 28B. Therefore, base station 28A communicates bi-directionally with wireless transceiver 24A, utilizing a digital spread spectrum technology with frequency hopping. Digital spread spectrum technology allows base stations 28 to continually scan the operating frequencies to find the clearest communication channel. Frequency hopping ensures that communications between base stations 28 and wireless transceivers 24 remain private. Base stations 28A-28n are connected to audio/visual modem 34 and channel selector 32. Audio signals generated by an employee wearing headset 22A, for instance, are communicated to base station 28A, then to audio/visual modem 34 for transport through Internet 14 to control center 12. Channel selector 32 allows control center 12 to receive audio signals from or to transmit audio signals to a particular headset 22A-22n. Therefore, if three employees are working at remote location 16A, control center 12 uses channel selector 32 to send and receive audio information to a particular employee. Audio/visual modem 34 transmits video signals from cameras 18 and audio signals from a selected headset 22 via the Internet 14 to control center 12.

Control center 12 includes audio/visual modem 36 connected to workstation 38. Each workstation 38 includes a computer system 40, a number of monitors 42A-42n, audio amplifier 44, headset 46, and enterprise server 48. Enterprise server 48 stores information related to each remote site 16, including configuration information required to receive video and audio information from each remote site 16. Configuration data includes Internet addresses necessary to receive data from particular remote locations 16, as well as hardware addresses of each audio/visual modem 34, which act as a security password to prevent unauthorized access to video or audio information. Computer system 40 is connected to audio/visual modem 36, and displays video images received from remote sites 16 onto the number of monitors 42A-42n. Because of quad-splitter 20 located at remote location 16, each monitor 42 can show video related to four video cameras 18 at a single remote location 16. With a number of monitors 42A-42n, an operator at control center 12 can visually inspect a number of remote locations 16 at one time. Audio amplifier 44 receives incoming audio data from a selected remote site 16 and transmits audio information to headset 46, as well as receives audio information from headset 46 for transmission to remote site 16.

In one exemplary embodiment, an operator at control center 12 selects a particular remote location 16A to visit. Information regarding connecting to remote site 16A is stored on enterprise server 48. This data is used to select remote location 16A from the plurality of remote locations 16 available. Video information from remote location 16A is displayed on one of the plurality of monitors 42. The operator manipulates cameras 18 remotely to view different portions of remote location 16A, or uses a zoom function located on cameras 18 to focus more closely on an object or person. Quad-splitter 20 implemented on the remote location side allows a single monitor 42 to display up to four camera feeds at once from remote location 16A. The operator reviews the video information to ensure remote location 16A is being properly maintained for business, that the correct number of employees are present, and that the employees are assisting customers correctly. The operator may decide from the visual inspection provided by cameras 18 that no need exists to communicate directly with any employees at remote location 16A. At any time, the operator may decide that direct communication is necessary at a particular remote location 16A. For example, the operator may notice from the visual inspection that corrections are required to better prepare remote location 16A for business, or that an opportunity exists to coach or train an employee at remote location 16A. Depending on the particular employee the operator wishes to talk to, the operator will select an audio channel, using audio output channel selector 32, which is associated with that employee's headset 22. For example, if operator wants to talk with the employee wearing headset 22A, the operator uses channel selector 32 to select the audio channel associated with headset 22A. Once an audio channel has been selected, the operator and employee can communicate with one another in real time. The operator speaks into the microphone attached to headset 46, which relays the audio signal to audio amplifier 44, and then to audio/visual modem 36, through Internet 14 to audio/visual modem 34, to base station 28A, to wireless transceiver 24A, and finally to the employee's headset 22A that the operator wants to talk with. Likewise, the employee speaks into the microphone attached to headset 22A, which relays the audio signal to wireless transceiver 24A, which relays audio signal to base station 28A, to audio/visual modem 34, through Internet 14, to audio/visual modem 36 at control center 12, to audio amplifier 44, and finally to the operator's headset 46. In this way, the operator may provide real time assistance and guidance to the employee remotely. While connected to a particular remote site 16A, the operator may switch audio channels and individually speak to any one of a number of employees. Alternatively, the operator may decide to broadcast an audio message to every employee's headset 22A-22n at remote location 16A. Once the operator is satisfied that a particular remote location 16A is functioning within guidelines, the operator uses enterprise server 48 to access the next remote location 16B, or whichever remote location 16 the operator decides to visit next. This allows the operator to visit a number of remote locations 16 in a very short amount of time. In another exemplary embodiment, enterprise server 48 automatically loads the next one of remote locations 16 to be visited, and ensures that each remote location 16 is visited in sequential order.

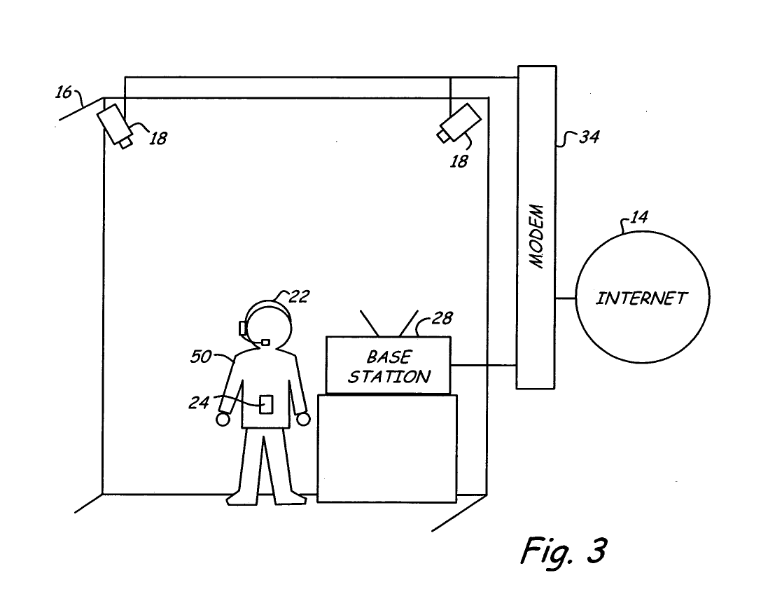

FIG. 3 is a perspective view of an exemplary embodiment of the present invention, illustrating the set-up of remote location 16. Cameras 18 are placed in positions allowing maximum field of range for an operator. An operator at control center 12 also has the ability to manipulate the direction of cameras 18, as well as manipulating the zoom function of cameras 18 in order to more closely inspect particular objects. Employee 50 is outfitted with headset 22, and wireless transceiver 24, which allows employee to move about the remote location while communicating with control center 12. Base station 28 is setup within remote location 16, which receives and transmits audio signals between employee 50 and an operator by communicating with employee 50 through wireless transceiver 24 and with the operator through audio/visual modem 34. As discussed above, each headset 22 is associated with a particular wireless transceiver 24 and a particular base station 28. Therefore, if more than one employee is present, more than one headset 22, wireless transceiver 24 and base station 28 will be required.

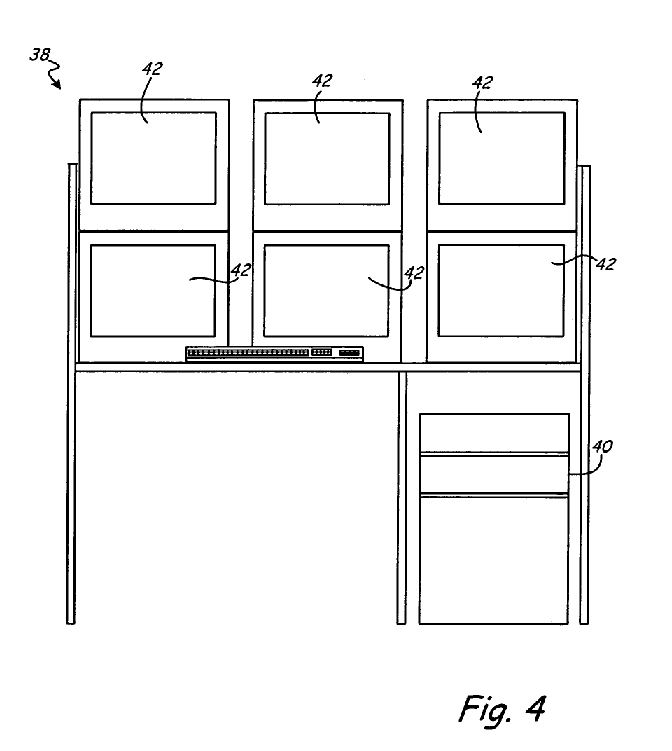

FIG. 4 is a perspective view of an exemplary embodiment of the present invention, illustrating the set-up of a single workstation 38 located in control center 12. As shown, workstation 38 includes a number of monitors 42 allowing an operator to simultaneously monitor video information from a number of remote locations 16. The operator uses computer system 38 to select contact and configuration data stored on enterprise server 48 (shown in FIG. 2) to select particular remote locations 16 to visit. In the exemplary embodiment shown in FIG. 4, the operator monitors five remote locations 16 simultaneously on five different monitors 42. The sixth monitor is reserved for situations in which an employee at remote location 16 requests assistance, either by email or pager.

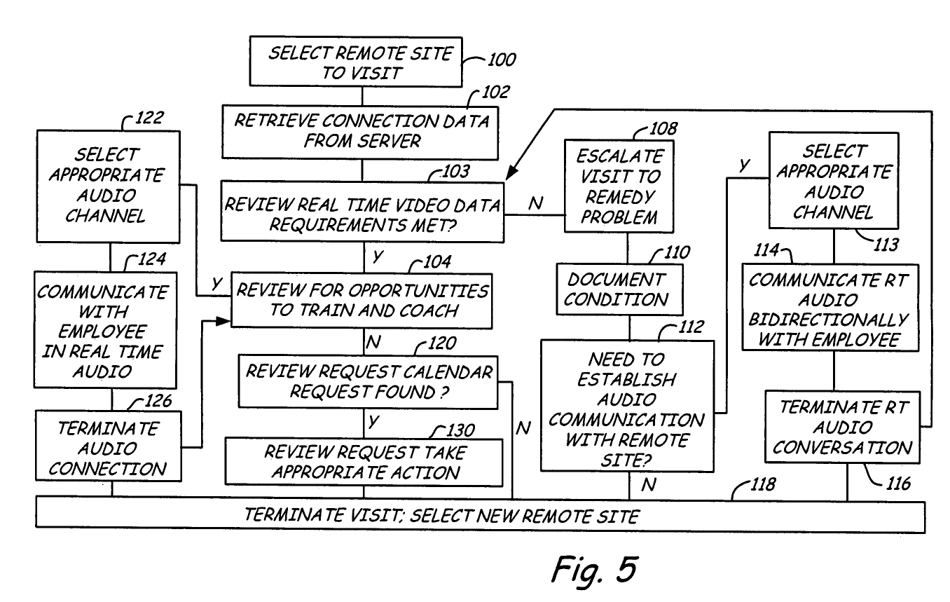

FIG. 5 is a flow chart illustrating a method of operating the system. Operation begins at step 100, which requires selection of a remote location to visit. In one exemplary embodiment, selection of remote location is done automatically by computer 38 (shown in FIG. 2), which serially selects remote locations from a list of all remote locations to be reviewed. In other exemplary embodiments, the operator decides which remote locations to visit, either by discretion or by request from a particular remote location for assistance. During step 102, computer 38 accesses enterprise server 48 to retrieve connection data and security passwords required to initiate contact with remote site. Once connection data and security information is retrieved, real time video information from remote location is loaded onto monitors. Step 103 requires the operator to review initial visual requirements, including but not limited to staffing levels in accordance with the schedule, the general appearance of the location, as well as the general appearance of the employees, and the overall readiness of the location to conduct business. If all visual conditions are met, then the operator may proceed to Step 104 in which the operator reviews the situation for opportunities to provide guidance and coaching. If all visual conditions are not met, then operator must determine the level of escalation required to remedy the situation, as indicated by Step 108. Operator may decide to document the condition leading to the escalation, shown by Step 110, or the operator may decide to establish audio communication with an employee at the remote location, shown by Step 112. If the operator decides to establish audio communication with an employee at the remote location to remedy the escalation, the operator selects the appropriate audio channel in order to communicate with a particular employee, Step 113. Once the appropriate audio channel is selected, the operator provides real time verbal communication with the employee, Step 114. During Step 114, the employee and the operator can communicate verbally with one another. After the problem leading to the escalation has been resolved, the operator terminates the audio communication, Step 116. The operator may then terminate the remote visit, Step 118, or continue the visit by reviewing visual conditions, Step 103. If the operator continues the visit, then the operator reviews real time video information from the remote site to see that all visual requirements are met, Step 103. Assuming all visual requirements are met, the operator reviews the remote site for opportunities to provide real time coaching or training, Step 104. If no opportunities for coaching or training present themselves, then the operator reviews a request calendar, Step 120. If opportunities for coaching or training are present, then the operator will select an audio channel corresponding to the employee to be coached or trained, Step 122. The operator then initiates real time audio communication with the employee regarding the training or coaching, Step 124. When the training or coaching session has ended, the operator terminates the audio communication with the employee, Step 126. The operator can either terminate the remote visit to this particular remote location, Step 118, or continue reviewing the remote site for opportunities to provide coaching or training, Step 104.

If no further opportunities for coaching are present, the operator reviews a request calendar, Step 120. The request calendar may include any particular concerns a former operator or manager of a location has about an employee or remote location. The request calendar acts as a note to the operator requesting that the operator watch for something in particular. For instance, if a particular employee has made a habit of coming in late, a manager may request an operator reviewing that particular remote site to make a note of whether this particular employee was at work on time. If no request are found in the request calendar, then the operator terminates the visit to the remote location, Step 118. If the operator finds a request in the request calendar, then the operator escalates the visit to a request process, Step 130. After documenting a response to the request process, the operator proceeds to terminate the visit to the remote location, Step 118.

A number of tools are made available to the operator during the process. For instance, in documenting conditions, the operator may record snapshots of incoming video images. In coaching or training exercises the operator may, instead of selecting an individual channel to communicate with a particular employee, select to broadcast to each employee at the remote location a particular training or coaching bit of advice. The broadcast mode is also useful in making announcements of changes of policy or in communicating any general messages.

Although the present invention has been described with reference to preferred embodiments, workers skilled in the art will recognize that changes may be made in form and detail without departing from the spirit and scope of the invention.

1. A method of providing distance assistance comprising:
selecting a first remote location to visit from a central location;
monitoring an interaction at the remote location between a representative and a customer with real time audio and video transmitted from the remote location to the central location over a network; and
providing verbal instructions privately to the representative, transmitted from the central location to the remote location over the network, to assist the representative in the interaction with the customer.

2. The method of claim 1, further including reviewing real time audio and video transmitted from the remote location to the central location over a network for opportunities to provide training or coaching to the representative.

3. The method of claim 1, further including selecting a first real time audio signal associated with a first representative from a plurality of audio signals associated with a plurality of representatives at the remote location to receive audio signals from.

4. The method of claim 3, further including providing verbal instructions privately to the first representative at the remote location.

5. The method of claim 3, further including providing verbal instructions to the plurality of representatives at the remote location simultaneously.

6. The method recited in claim 1, further including selecting a second remote site to visit from a plurality of remote sites.

7. The method of claim 1, further including retrieving an Internet address associated with a modem at the remote location.

8. The method of claim 7, further including using the Internet address to establish a connection between the remote site and the central location.

9. A distance assistance system, comprising:
a plurality of remote locations;
a central location, wherein an operator selects remote locations to visit from the plurality of remote locations available;
a video means for monitoring conditions at the plurality of remote locations, wherein a video signal is transmitted from selected remote locations to the central location through a network; and
a bi-directional audio means for monitoring conditions at the plurality of remote locations as well as for providing verbal instructions to a plurality of representatives located at the plurality of remote locations, wherein audio signals are transmitted between selected remote locations and the central location through the network.

10. The distance assistance system of claim 9, wherein the video means includes a camera located at each of the plurality of remote locations.

11. The distance assistance system of claim 9, wherein the video means includes a plurality of cameras located at each of the plurality of remote locations.

12. The distance assistance system of claim 9, wherein the video means includes a plurality of cameras and a quad-splitter located at each of the plurality of remote locations.

13. The distance assistance system of claim 9, wherein the bi-directional audio means includes a first headset worn by one of the plurality of representatives for receiving and transmitting real time audio signals and a second headset worn by an operator at the central location for receiving and transmitting real time audio signals.

14. The distance assistance system of claim 9, wherein the bi-directional audio means includes a plurality of headsets worn by each of the plurality of representatives for receiving and transmitting real time audio signals.

15. The distance assistance system of claim 14, wherein the bi-directional audio means includes a channel selector, wherein the channel selector allows the operator at the central location to select headsets from the plurality of headsets to transmit and receive real time audio signals.

16. A method of providing distance assistance comprising:
selecting a first remote location to visit from a central location;
retrieving an Internet address associated with a modem at the remote location;
using the Internet address to establish a connection between the remote site and the central location;
monitoring an interaction at the remote location between a representative and a customer with real time audio and video transmitted from the remote location to the central location over a network; and
providing verbal instructions privately to the representative, transmitted in real time from the central location to the remote location over the network, to assist the representative in the interaction with the customer.
